(19) United States
(12) Patent Application Publication
(10) Pub. No.: US 2006/0202910 A1
(43) Pub. Date: Sep. 14, 2006

(54) 2D/3D switchable display

(75) Inventors: Kyung-hoon Cha, Yongin-si (KR); Sergey Shestak, Suwon-si (KR); Dae-sik Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/366,414

(22) Filed: Mar. 3, 2006

Related U.S. Application Data
(60) Provisional application No. 60/657,724, filed on Mar. 3, 2005.

(30) Foreign Application Priority Data
Apr. 6, 2005 (KR) 10-2005-0028661

(51) Int. Cl. G09G 5/00

(52) U.S. Cl. 345/6

(57) ABSTRACT

Provided is a two-dimension/three-dimension (2D/3D) switchable display. The 2D/3D switchable display includes: a display device which generates an image; a first optical element which includes convex lens cells; a second optical element which includes concave lens cells that-coincide with the convex lens cells of the first optical element; and a driving unit which moves at least one of the first and second optical elements along an optical axis, wherein a two dimensional (2D) image is formed when the first optical element and the second optical element are matched with each other and a three dimensional (3D) image is formed when the first optical element and the second optical element are separated a predetermined distance from each other along the optical axis.

### CROSS-REFERENCE TO RELATED PATENT APPLICATION

This application claims priority from U.S. patent application Ser. No. 60/657,724, filed on Mar. 3, 2005, and Korean Patent Application No. 10-2005-0028661, filed on Apr. 6, 2005, and in the Korean Intellectual Property Office, the disclosures of which are incorporated herein in their entirety by reference.

### BACKGROUND OF THE INVENTION

1. Field of the Invention

An apparatus consistent with the present invention relates to a two-dimension/three-dimension (2D/3D) switchable display, and more particularly, to an image display that can easily switch between a two dimensional (2D) mode and a three dimensional (3D) mode.

2. Description of the Related Art

In general, a three dimensional (3D) image is made based on the principle of stereo image sensing by two human eyes. Binocular parallax occurring due to the eyes being separated by about 65 mm from each other is the most important factor for producing a cubic effect. 3D image displays are divided into displays using glasses and glassesless displays. Glassesless displays produce a 3D image by separating left and right images without using glasses. Glassesless displays are divided into parallax barrier type displays and lenticular type displays.

In a parallax barrier type display, images to be seen by left and right eyes are printed or photographed in an alternating vertical pattern produced using a very thin vertical lattice, that is, a barrier. Thus, a vertical pattern image to be seen by the left eye and a vertical pattern image to be seen by the right eye are separated by the barrier and the left and right eyes see images at different viewpoints so as to see a 3D image.

In the lenticular type display, images for left and right eyes are placed in focal planes of a lenticular lens, and the lecticular lens is formed such that the images are separately formed in the left eye and the right eye according to lens refraction so as to produce a 3D image.

There are demands to see a two dimensional (2D) image using a 3D image display. To fulfill these demands, a two-dimension/three-dimension (2D/3D) switchable display has been developed. A 2D/3D switchable display using a lenticular lens is disclosed in U.S. Patent Publication No. 2004/0041747A.

FIGS. 1A and 1B are sectional views of the conventional image display disclosed in U.S. Patent Publication No. 2004/0041747. Referring to FIGS. 1A and 1B, the conventional image display 1 includes a display device 2 comprised of alternating pixels 41 and 42 respectively for a left eye 51 and a right eye 52, and first and second optical units 31 and 32 refracting light incident from the pixels 41 and 42.

Lens cells of the first optical unit 31 and lens cells of the second optical unit 32 have the same pitch. A 3D image is obtained by offsetting the first optical unit 31 relative to the second optical unit 32 by a half of the pitch, and a 2D image is obtained by moving the first optical unit 31 so that the first optical unit 31 and the second optical unit 32 are not offset. The conventional image display moves the first optical unit 31 in a direction 11 perpendicular to an optical axis to switch between a 2D image and a 3D image. Since the first optical unit 31 should be moved along the non-planar contour of the second optical unit 32, the moving mechanism of the first optical unit 31 is complicated.

Further, when a 3D image is formed, it is difficult to accurately move the first optical unit 31 by half of the pitch of the lens cells of the second optical unit 32. There is little crosstalk at an optimal point in a 3D mode, but crosstalk increases greatly at the center of a viewing zone, thereby deteriorating image quality and brightness. Accordingly, an image not containing crosstalk can only be seen in a very narrow range.

### SUMMARY OF THE INVENTION

The present invention provides an image display which can easily switch between a 2D mode and a 3D mode and can effectively separate viewing zones.

According to an aspect of the present invention, there is provided a 2D/3D switchable display comprising: a display device which generates an image; a first optical element which includes convex lens cells; a second optical element which includes concave lens cells which coincide with the convex lens cells of the first optical element; and a driving unit which moves at least one of the first and second optical elements along an optical axis, wherein a 2D image is formed when the first optical element and the second optical element are matched with each other and a 3D image is formed when the first optical element and the second optical element are separated a predetermined distance from each other along the optical axis.

The 3D image may be formed when the first optical element and the second optical element are separated from each other by a distance equal to the focal length of the first and second optical elements.

The first optical element may be a convex lenticular lens, and the second optical element may be a concave lenticular lens.

The first optical element and the second optical element may have equal and opposite focal lengths.

The convex lens cells and the concave lens cells may have the same pitch and the same curvature.

According to another aspect of the present invention, there is provided a 2D/3D switchable display comprising: a display device which generates an image; a first prism element which includes first prism units; a second prism element which includes second prism units that coincide with the first prism units of the first prism element; and a driving unit which moves at least one of the first and second prism elements along an optical axis, wherein a 2D image is formed when the first prism element and the second prism element are matched with each other and a 3D image is formed when the first prism element and the second prism element are separated a predetermined distance from each other along the optical axis.

The first prism units and the second prism units may have the same pitch and the same prism angle.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are sectional views of a conventional two-dimension/three-dimension (2D/3D) switchable display disclosed in U.S. Patent Publication No. 2004/0041747 A1;

FIG. 2A is a sectional view of a 2D/3D switchable display according to an exemplary embodiment of the present invention in a two dimensional (2D) mode;

FIG. 2B is a sectional view of the 2D/3D switchable display of FIG. 2A in a three dimensional (3D) mode;

FIG. 3A illustrates simulation results of the image formed by the 2D/3D switchable display of FIG. 2A in a 2D mode;

FIG. 3B illustrates simulation results of the image formed by the 2D/3D switchable display of FIG. 2B in a 3D mode;

FIGS. 4A through 4C are perspective views of various examples of first and second optical elements included in the 2D and 3D switchable display of FIG. 2A and 2B respectively;

FIG. 5A is a sectional view of a 2D/3D switchable display according to another exemplary embodiment of the present invention in a 2D mode; and

FIG. 5B is a sectional view of the 2D/3D switchable display of FIG. 5A in a 3D mode.

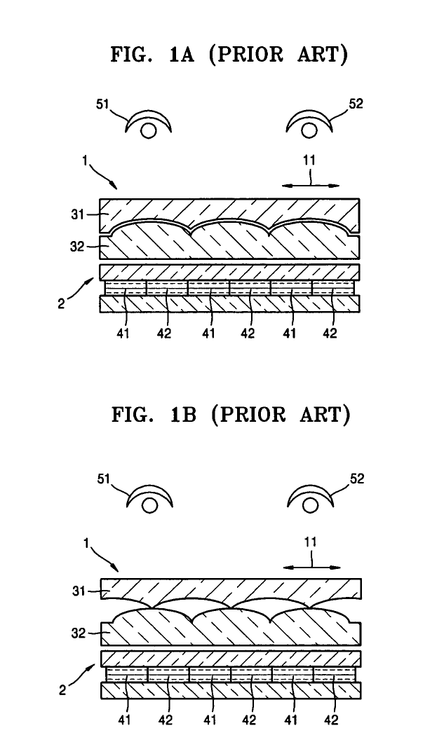

### DETAILED DESCRIPTION OF THE INVENTION

The present invention will now be described more fully with reference to the accompanying drawings, in which exemplary embodiments of the invention are shown.

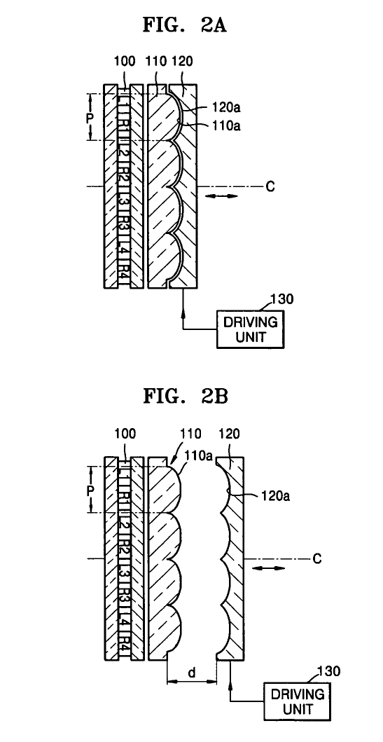

FIG. 2A is a sectional view of a two-dimension/three-dimension (2D/3D) switchable display according to an exemplary embodiment of the present invention in a two dimensional (2D) mode. FIG. 2B is a sectional view of the 2D/3D switchable display of FIG. 2A in a three dimensional (3D) mode.

Referring to FIG. 2A, the 2D/3D switchable display includes a display device 100 which generates an image, and a first optical element 110 and a second optical element 120 which switches between a 2D mode and a 3D mode.

The display device 100 may be a liquid crystal display (LCD). The first and second optical elements 110 and 120 have complementary contours, and at least one of the first and second optical elements 110 and 120 can be moved by a driving unit 130 along an optical axis C. As a non-limiting example, the driving unit 130 may move only the second optical element 120 along the optical axis C as shown in FIG. 2A. The first optical element 110 may be a first lenticular lens which includes cylindrical convex lens cells 110a. The second optical element 120 may be a second lenticular lens which includes cylindrical concave lens cells 120a. The first optical element 110 and the second optical element 120 are disposed so that the cylindrical convex lens cells 110a and the cylindrical concave lens cells 120 can face each other.

The cylindrical convex lens cells 110a and the cylindrical concave lens cells 110b have the same focal length, the same pitch P, and the same curvature. Since the cylindrical convex lens cells 110 and the cylindrical concave lens cells 110b have complementary contours as shown in FIG. 2A, the first optical element 110 and the second optical element 120 can be matched with each other. When the focal length of the first optical element 110 is “f”, the focal length of the second optical element 120 is “−f”. The 2D mode and a 3D mode can be switched between by moving the second optical element 120 along the optical axis C to adjust a distance, d, between the first optical element 110 and the second optical element 120. The principle of forming 2D and 3D images using the first and second optical elements 110 and 120 will now be explained.

When the two optical elements 110 and 120 respectively having the focal lengths f1 and f2 are separated by the distance d from each other, a composite focal length f12 is expressed by the following equation:
f₁₂=(f₁f₂)/(f₁+f₂−d) (1).

When the first optical element 110 and the second optical element 120 are matched with each other as shown in FIG. 2A, that is, when d=0, the composite focal length f12 is infinite according to Equation 1, such that incident light is transmitted through the first optical element 110 and the second optical element 120. That is, since the first optical element 110 and the second optical element 120 substantially act as one transparent plate, an image generated by the display device 100 is transmitted straight through the first and second optical elements 110 and 120, and thus the same image is formed for left and right eyes to see a 2D image.

On the other hand, when the first optical element 110 and the second optical element 120 are separated by the distance d from each other as shown in FIG. 2B, the first and second optical elements 110 and 120 have the composite focal length f12 according to Equation 1. For example, when the first optical element 110 and the second optical element 120 are separated from each other by the distance “d” equal to the focal length f (d=f=f₁=−f₂), viewing zones of left and right eye images generated by the display device 100 are separated so that a viewer can see a 3D image. Using Equation 1, the composite focal length, f₁₂, with respect to the distance d between the first and second optical elements 110 and 120 is expressed by the following equation:

$${f}_{12} = \frac{{f}^{2}}{d} . \qquad ( 2 )$$

Referring to Equation 2, when d=f, the composite focal length f₁₂ of the first and second optical elements 110 and 120 is equal to the focal length f. Accordingly, when the first and second optical elements 110 and 120 are separated from each other by the focal length f, the two optical elements 110 and 120 act as a single optical element. That is, the two lenticular lenses act as one lenticular lens, and thus a viewing zone of an image generated by the display device 100 is separated and focused to realize a 3D image.

When a 3D image is formed, left-eye image signals L₁ to Lₙ and right-eye image signals R₁ to Rₙ, where “n” is a natural number, are output from pixels of the display device 100, and viewing zones of an image for a left eye and an image for a right eye are separated according to the left-eye image signals L₁ to Lₙ and the right-eye image signals R₁ to Rₙ by the first and second optical elements 110 and 120, such that the left-eye image and the right-eye image are respectively formed in the left eye and the right eye to see a 3D image.

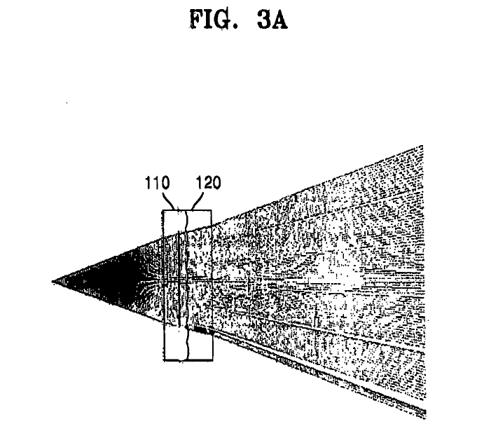

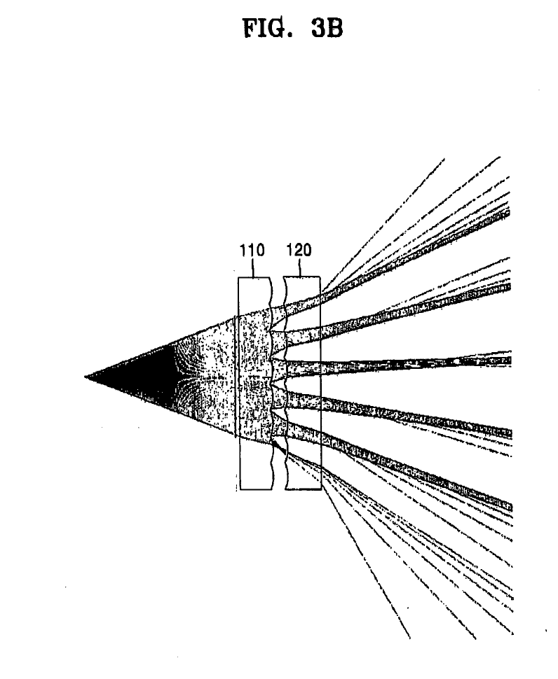

FIG. 3A illustrates simulation results of a 2D image formed when the first and second optical elements 110 and 120 are matched with each other. FIG. 3B illustrates simulation result of a 3D image formed when the first and second optical elements 110 and 120 are spaced from each other by a distance equal to the focal length “f” and viewing zones of a left-eye image and a right-eye image are separated such that the left-eye image and the right-eye image are respectively formed in left and right eyes.

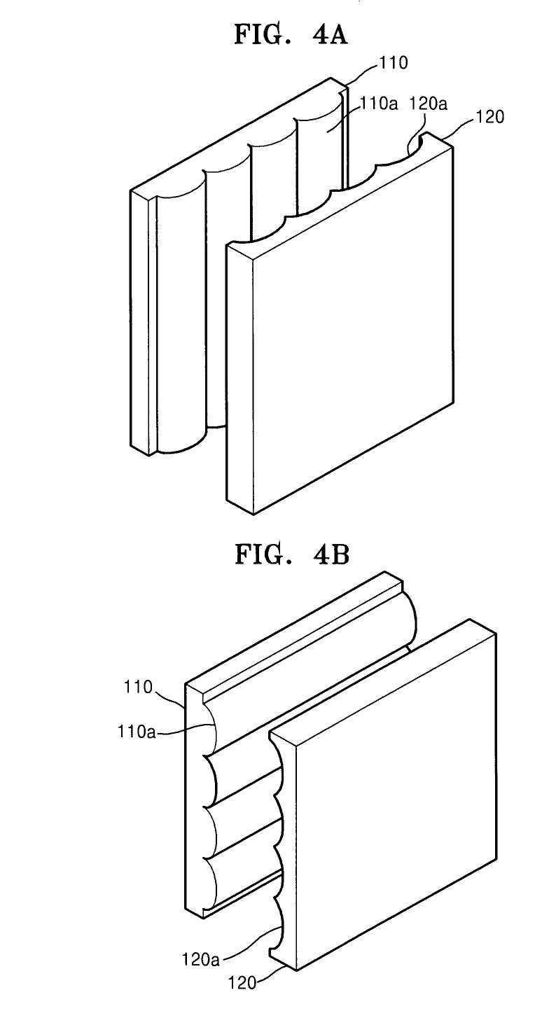

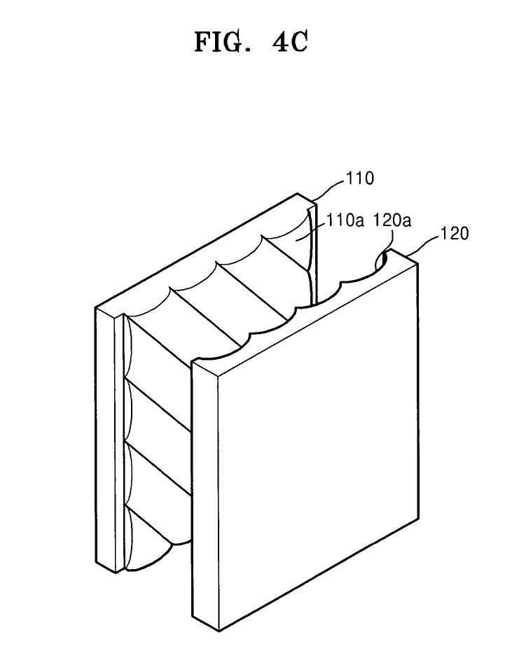

The cylindrical lens cells 110a and 120a of the first and second optical elements 110 and 120 may be arranged vertically as shown in FIG. 4A, arranged horizontally as shown in FIG. 4B, or inclined at a predetermined angle θ, as shown in FIG. 4C.

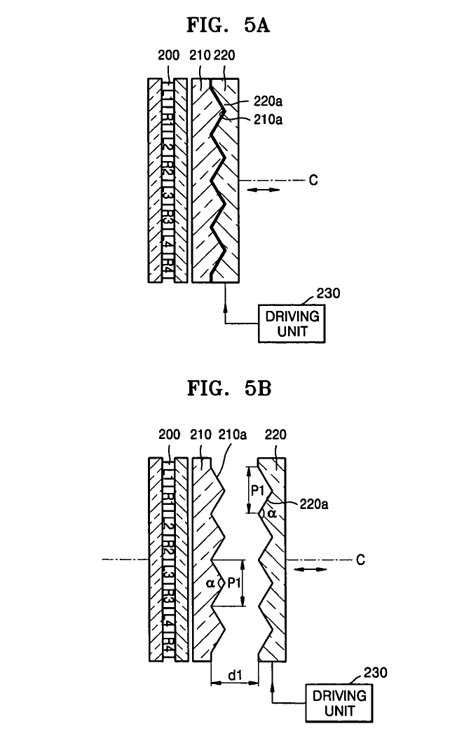

FIG. 5A is a sectional view of a 2D/3D switchable display according to another exemplary embodiment of the present invention

Referring to FIG. 5A, the 2D/3D switchable display includes a display device 200 which generates an image, and a first prism element 210 and a second prism element 220 which switches between a 2D mode and 3D mode.

The display device 200 may be an LCD. The first prism element 210 includes first prism units 210a, and the second prism element 220 includes second prism units 220a. The first prism units 210a and the second prism units 220a may have the same pitch P, the same prism angle “α”, and complementary contours. The first prism units 210a and the second prism units 220a face each other. The first prism element 210 and the second prism element 220 may have the same refractive index.

At least one of the first prism element 210 and the second prism element 220 may be moved by a driving unit 230 along an optical axis C. As a non-limiting example, the second prism element 220 may be moved along the optical axis C as shown in FIGS. 5A and 5B. Since the first prism element 210 and the second prism element 220 have the complementary contours, the two prism elements 210 and 220 can be matched with each other.

When the first prism element 210 and the second prism element 220 are matched with each other as shown in FIG. 5A, since the two prism elements 210 and 220 have the same refractive index, they act as one plate, such that an image generated by the display device 200 is transmitted through the first and second prism elements 210 and 220 and the same image is formed in left and right eyes to realize a 2D image.

FIG. 5B is a sectional view of the 2D/3D image display of FIG. 5A when the first prism element 220 is moved a distance d1 along the optical axis C. In this case, viewing zones of a left-eye image and a right-eye image are separated to realize a 3D image.

The 2D/3D switchable display according to the present invention can easily switch between a 2D mode and 3D mode by moving at least one of the pair of optical elements that have the complementary contours along the optical axis. Also, the 2D/3D switchable display uses both of the pair of optical elements on both sides of a 2D image and a 3D image without removing one of the optical elements to form a 3D image.

As described above, the image display according to the present invention can easily switch between a 2D mode and a 3D mode by moving at least one of the pair of optical elements that have the complementary contours along the optical axis. Accordingly, the image display can simply provide both a 2D image and a 3D image by adding one optical element that has a complementary contour of an existing 2D image display.

While the present invention has been particularly shown and described with reference to exemplary exemplary embodiments thereof, it will be understood by those of ordinary skill in the art that various changes in form and details may be made therein without departing from the spirit and scope of the present invention as defined by the following claims.

What is claimed is:

1. A 2D/3D switchable display comprising:
a display device which generates an image;
a first optical element comprising convex lens cells;
a second optical element comprising concave lens cells that coincide with the convex lens cells of the first optical element; and
a driving unit which moves at least one of the first and second optical elements along an optical axis,
wherein a 2D image is formed when the first optical element and the second optical element are matched with each other and a 3D image is formed when the first optical element and the second optical element are separated a predetermined distance from each other along the optical axis.

2. The 2D/3D switchable display of claim 1, wherein the 3D image is formed when the first optical element and the second optical element are separated from each other by a distance equal to the focal length of the first and second optical elements.

3. The 2D/3D switchable display of claim 2, wherein each of the first optical element and the second optical element includes cylindrical lens cells that are arranged vertically or horizontally or are inclined at a predetermined angle.

4. The 2D/3D switchable display of claim 2, wherein the first optical element is a convex lenticular lens, and the second optical element is a concave lenticular lens.

5. The 2D/3D switchable display of claim 1, wherein the first optical element and the second optical element have equal and opposite focal lengths.

7. The 2D/3D switchable display of claim 1, wherein the convex lens cells and the concave lens cells have the same pitch and the same curvature.

8. The 2D/3D switchable display of claim 1, wherein each of the first optical element and the second optical element includes cylindrical lens cells that are arranged vertically or horizontally or are inclined at a predetermined angle.

9. The 2D/3D switchable display of claim 1, wherein the first optical element is a convex lenticular lens, and the second optical element is a concave lenticular lens.

10. A 2D/3D switchable display comprising:
a display device which generates an image;
a first prism element comprising first prism units;
a second prism element comprising second prism units that coincide with the first prism units of the first prism element; and
a driving unit which moves at least one of the first and second prism elements along an optical axis,
wherein a 2D image is formed when the first prism element and the second prism element are matched with each other and a 3D image is formed when the first prism element and the second prism element are separated a predetermined distance from each other along the optical axis.

11. The 2D/3D switchable display of claim 10, wherein the first prism units and the second prism units have the same pitch and the same prism angle.
